(19) United States
(12) Patent Application Publication
(10) Pub. No.: US 2016/0127739 A1
(43) Pub. Date: May 5, 2016

(54) MOTION SEARCH PROCESSING METHOD AND DEVICE

(71) Applicant: FUJITSU LIMITED, Kawasaki-shi (JP)

(72) Inventors: Yoshihiro Terashima, Fukuoka (JP); CHIKARA IMAJO, Fukuoka (JP); YASUO MISUDA, Inagi (JP)

(21) Appl. No.: 14/833,863

(22) Filed: Aug. 24, 2015

(30) Foreign Application Priority Data
Oct. 31, 2014 (JP) 2014-223640

(51) Int. Cl. H04N 19/513; H04N 5/14

(52) U.S. Cl. CPC H04N 19/513; H04N 5/144

(57) ABSTRACT

A motion search processing method includes: dividing, by a computer, first image data included in video data in accordance with a frequency band and generating a plurality of pieces of divided image data; performing compression processing on first divided image data among the plurality of pieces of divided image data and generating compressed divided image data, the first divided image data including a frequency component of which a frequency band is equal to or more than a value; performing first motion search processing on the video data by using second divided image data among the plurality of pieces of divided image data, the second divided image data including a frequency component of which a frequency band is less than the value; and generating second image data by using the plurality of pieces of divided image data and performing second motion search processing by using the second image data.

### CROSS-REFERENCE TO RELATED APPLICATION

This application is based upon and claims the benefit of priority of the prior Japanese Patent Application No. 2014-223640, filed on Oct. 31, 2014, the entire contents of which are incorporated herein by reference.

### FIELD

The embodiment discussed herein is related to motion search processing and so forth.

### BACKGROUND

In image coding processing in which a moving image is compressed, a motion vector is obtained by performing block matching of previous and following frames of input image data. Discrete cosine transform (DCT) quantization and entropy coding are performed based on the motion vector which is obtained.

A related technique is disclosed in Japanese Laid-open Patent Publication No. 2014-42139, Japanese Laid-open Patent Publication No. 2010-41624, Japanese Laid-open Patent Publication No. 2011-4345, or Japanese Laid-open Patent Publication No. 9-322160.

### SUMMARY

According to an aspect of the embodiments, a motion search processing method includes: dividing, by a computer, first image data included in video data in accordance with a frequency band and generating a plurality of pieces of divided image data; performing compression processing on first divided image data among the plurality of pieces of divided image data and generating compressed divided image data, the first divided image data including a frequency component of which a frequency band is equal to or more than a value; performing first motion search processing on the video data by using second divided image data among the plurality of pieces of divided image data, the second divided image data including a frequency component of which a frequency band is less than the value; and generating second image data by using the plurality of pieces of divided image data and performing second motion search processing by using the second image data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of processing of an image coding processing unit;

FIG. 2 illustrates an example of processing of an image coding processing unit;

FIG. 3 illustrates an example of a motion search processing device;

FIG. 4 illustrates an example of a data configuration of a management table;

FIG. 5 illustrates an example of processing of a generation unit;

FIG. 6 illustrates an example of processing of a compression unit;

FIG. 7 illustrates an example of processing of a motion search unit;

FIG. 8 illustrates an example of processing of a motion search unit;

FIG. 9 illustrates an example of processing of a motion search processing device; and

FIG. 10 illustrates an example of a computer.

### DESCRIPTION OF EMBODIMENT

When a motion vector is obtained, an arithmetic amount is reduced by multi-stage motion search. Reduced image data is generated from input image data, first motion search is performed with respect to the reduced image data and a motion search range is narrowed down. An image corresponding to the narrowed motion search range is acquired from the input image data and second motion search is performed with respect to the acquired image data.

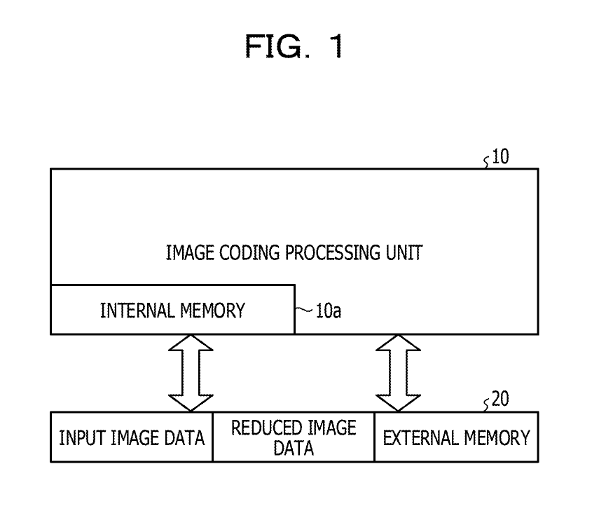

FIG. 1 illustrates an example of processing of an image coding processing unit. An image coding processing unit 10 reads input image data onto an internal memory 10a from an external memory 20, generates a reduced image corresponding to the input image data, and stores the reduced image data in the external memory 20. The image coding processing unit 10 reads the reduced image data from the external memory 20, performs first motion search and specifies a motion search range. The image coding processing unit 10 reads the input image data from the external memory 20, acquires an image within the motion search range, executes second motion search and obtains a motion vector. The image coding processing unit 10 performs DCT quantization and entropy coding based on the motion vector.

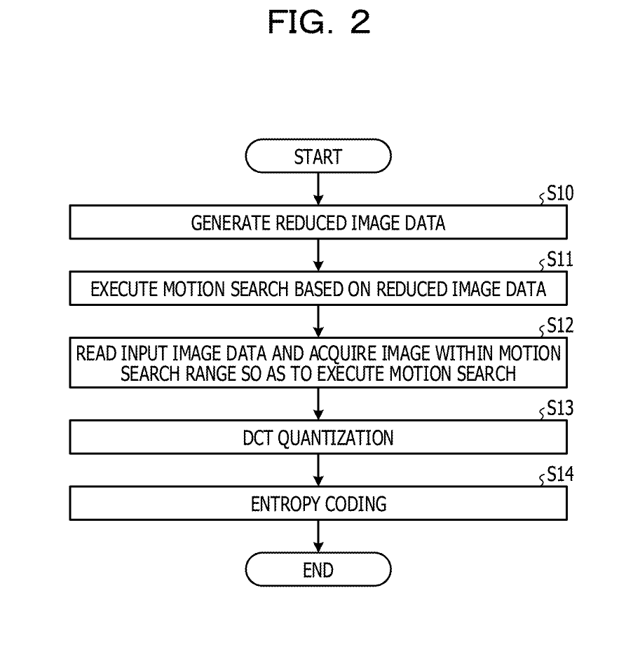

FIG. 2 illustrates an example of processing of an image coding processing unit. As illustrated in FIG. 2, the image coding processing unit 10 generates reduced image data based on input image data (operation S10) and executes motion search based on the reduced image data (operation S11). The image coding processing unit 10 reads the input image data, acquires an image within a motion search range and executes motion search (operation S12). The image coding processing unit 10 performs DCT quantization (operation S13) and performs entropy coding (operation S14).

For example, input image data and reduced image data are stored in the external memory 20, so that a memory capacity of the external memory 20 may increase and a transfer amount of data between the image coding processing unit 10 and the external memory 20 may increase. Therefore, it may take time for the image coding processing unit 10 to read data and thus, multi-stage motion search may not be executed efficiently.

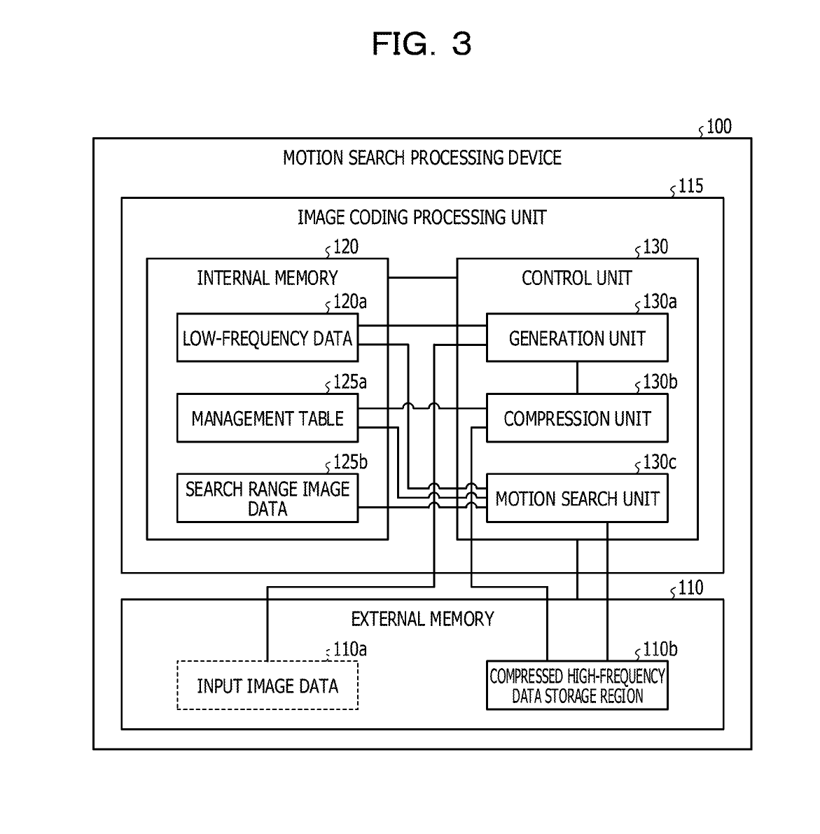

FIG. 3 illustrates an example of a motion search processing device. As illustrated in FIG. 3, this motion search processing device 100 includes an external memory 110 and an image coding processing unit 115.

The external memory 110 includes input image data 110a and a compressed high-frequency data storage region 110b. The input image data 110a is deleted from the external memory 110 after a generation unit 130a bandwidth-divides the input image data 110a into low-frequency data and high-frequency data. The external memory 110 may correspond to a storage device such as a semiconductor memory element which is a random access memory (RAM), a flash memory, or the like, for example.

The input image data 110a is image data which corresponds to one frame of a moving image. The input image data 110a is sequentially stored in the external memory 110 from an external device and is processed by the motion search processing device 100.

In the compressed high-frequency data storage region 110b, data obtained by compressing the high-frequency data of the input image data 110a is stored. The compressed high-frequency data storage region 110b is generated by a compression unit 130b and is stored in the external memory 110. In the following description, high-frequency data which is compressed may be expressed as compressed high-frequency data.

The image coding processing unit 115 executes motion search processing with respect to the input image data 110a which is sequentially stored in the external memory 110 and generates stream data. The image coding processing unit 115 outputs the generated stream data to an external device. The image coding processing unit 115 includes an internal memory 120 and a control unit 130.

The internal memory 120 includes low-frequency data 120a, a management table 125a, and search range image data 125b. For example, the internal memory 120 may correspond to a storage device such as a semiconductor memory element which is a RAM or the like.

The low-frequency data 120a may correspond to the low-frequency data of the input image data 110a.

The management table 125a is information for associating a position on the input image data 110a with an address on the compressed high-frequency data storage region 110b in which compressed high-frequency data corresponding to the position is held.

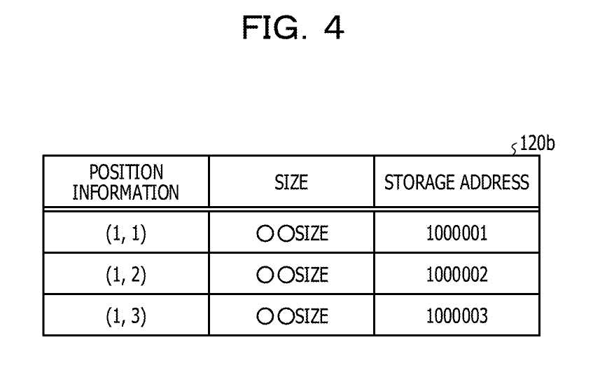

FIG. 4 illustrates an example of a data configuration of a management table. As illustrated in FIG. 4, the management table 125a associates position information, a size, and a storage address with each other. The position information is information for uniquely specifying a position on the input image data 110a. The position information may be specified by a coordinate or may be specified by an identification number of a block which is obtained in a case in which the input image data 110a is divided into a plurality of blocks. The size represents a data size of compressed high-frequency data which corresponds to the position information. The storage address represents an address on a compressed high-frequency data storage region in which the compressed high-frequency data corresponding to the position information is stored.

For example, in a record on the first row of FIG. 4, compressed high-frequency data corresponding to position information (1,1) on the input image data 110a is stored on an address “1000001” in the compressed high-frequency data storage region 110b. The size of the compressed high-frequency data is “00 size”.

The search range image data 125b is image data of a search range which is specified when first motion search is performed. In the following description, a search range which is specified when first motion search is performed may be expressed as a motion search range. A motion search unit 130c generates the search range image data 125b based on the low-frequency data 120a and compressed high-frequency data which are included in a motion search range.

The control unit 130 includes the generation unit 130a, the compression unit 130b, and the motion search unit 130c. The control unit 130 may correspond to an integrated device such as an application specific integrated circuit (ASIC) and a field programmable gate array (FPGA), for example. The control unit 130 may correspond to an electric circuit such as a central processing unit (CPU) and a micro processing unit (MPU), for example.

The generation unit 130a reads the input image data 110a which is stored in the external memory 110, divides the input image data 110a in accordance with a frequency band and generates low-frequency data and high-frequency data. The generation unit 130a stores the low-frequency data 120a in the internal memory 120. The generation unit 130a outputs the high-frequency data to the compression unit 130b.

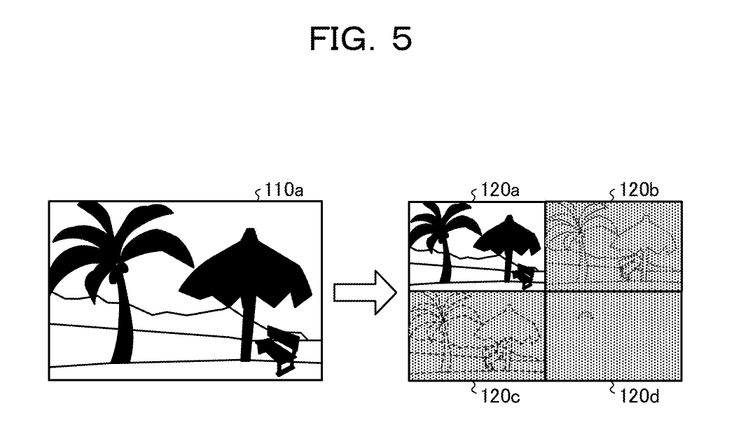

FIG. 5 illustrates an example of processing of a generation unit. The generation unit 130a executes the wavelet transform and divides the input image data 110a into low-frequency data 120a and high-frequency data 120b, 120c, and 120d. For example, the low-frequency data 120a may be image data of which a frequency band is equal to or lower than a frequency band A. The high-frequency data 120b, 120c, and 120d may be image data of which a frequency band is equal to or higher than the frequency band A.

The high-frequency data 120b is image data of which a frequency band is equal to or higher than the frequency band A and is lower than a frequency band B. The high-frequency data 120c is image data of which a frequency band is equal to or higher than the frequency band B and is lower than a frequency band C. The high-frequency data 120d is image data of which a frequency band is equal to or higher than the frequency band C and is lower than a frequency band D. The magnitude relation of frequency bands may be “frequency band A<frequency band B<frequency band C<frequency band D”, for example.

In FIG. 5, the generation unit 130a may divide the input image data 110a into the low-frequency data 120a and the high-frequency data 120b, 120c, and 120d, but division is not limited to this example. For example, the generation unit 130a may divide the input image data 110a into the low-frequency data 120a and one piece of high-frequency data including frequency bands of the high-frequency data 120b, 120c, and 120d.

The generation unit 130a deletes the input image data 110a which is stored in the external memory 110 after generating the low-frequency data and the high-frequency data from the input image data 110a on the external memory 110. Whenever new input image data 110a is stored in the external memory 110, the generation unit 130a repeatedly executes the above-described processing.

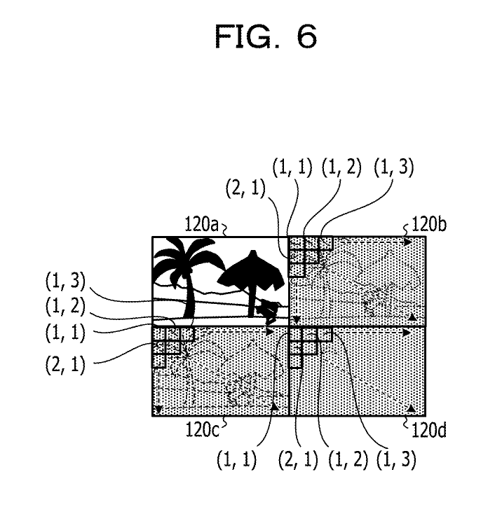

The compression unit 130b performs coding compression with respect to high-frequency data and generates compressed high-frequency data. FIG. 6 illustrates an example of processing of a compression unit. As illustrated in FIG. 6, the compression unit 130b performs coding compression with respect to the high-frequency data 120b to 120d by arbitrary pixel unit “(1,1), (1,2), . . . ”. For example, the compression unit 130b may perform entropy coding with respect to high-frequency data and generates compressed high-frequency data.

The compression unit 130b stores compressed high-frequency data in the compressed high-frequency data storage region 110b. The compression unit 130b registers position information of the input image data 110a which is a generation source of compressed high-frequency data, a size of the compressed high-frequency data, and an address on the compressed high-frequency data storage region 110b, in which the compressed high-frequency data is stored, in the management table 125a in such a manner that the position information, the size, and the address are associated with each other.

A low frequency band is not included in the high-frequency data 120b to 120d as described above, so that entropy of the data is low. Therefore, the data may be efficiently compressed through the entropy coding performed by the compression unit 130b and the size of the compressed high-frequency data may be reduced.

The motion search unit 130c performs motion search processing and obtains a motion vector. For example, the motion search unit 130c performs first motion search processing by using the low-frequency data 120a so as to specify a motion search range and generate the search range image data 125b. The motion search unit 130c performs second motion search processing with respect to the search range image data 125b and obtains a motion vector. The motion search unit 130c performs DCT quantization and entropy coding based on the motion vector and outputs a result of the entropy coding to an external device.

For example, the motion search unit 130c obtains a first motion vector. The motion search unit 130c compares a pixel value of low-frequency data 120a of a previous frame with a pixel value of low-frequency data 120a of a present frame, specifies a distance and a direction of motion of a shooting subject, and calculates a motion vector. The motion search unit 130c sets a region within a certain range around a coordinate of the motion vector as a motion search range.

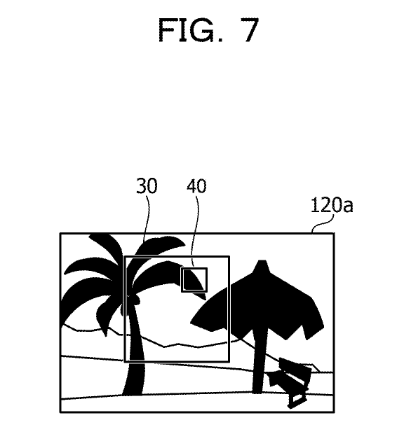

FIG. 7 illustrates an example of processing of a motion search unit. A region 30 of FIG. 7 represents an example of a region in which motion search is performed with respect to the low-frequency data 120a. The motion search unit 130c specifies a distance and a direction of motion of a shooting subject in the region 30 and calculates a motion vector. The motion search unit 130c sets a region within a certain range around a coordinate of the motion vector as a motion search range. In FIG. 7, the motion search unit 130c specifies a motion search range 40.

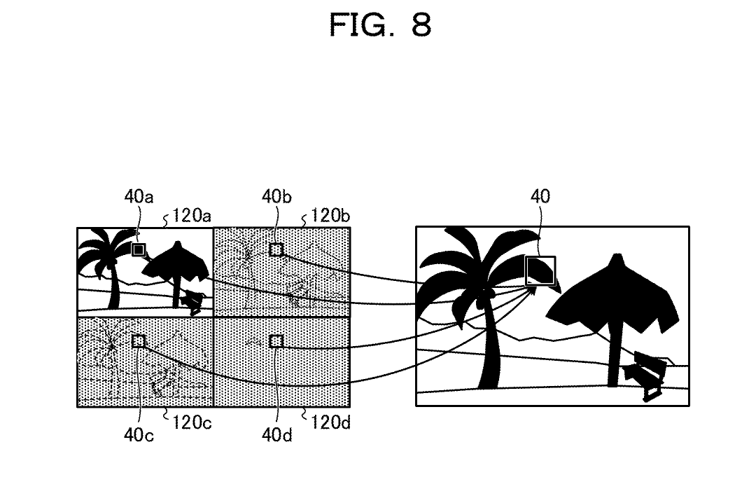

The motion search unit 130c generates the search range image data 125b based on the motion search range. FIG. 8 illustrates an example of processing of the motion search unit. The motion search unit 130c acquires data of a region corresponding to the motion search range 40 from the low-frequency data 120a and the high-frequency data 120b to 120d. For example, the motion search unit 130c acquires data of a region 40a of the low-frequency data 120a, data of a region 40b of the high-frequency data 120b, data of a region 40c of the high-frequency data 120c, and data of a region 40d of the high-frequency data 120d.

For example, the motion search unit 130c compares position information of the motion search range 40 with the management table 125a and acquires addresses on which compressed high-frequency data of the regions 40b, 40c, and 40d are respectively stored. The motion search unit 130c accesses the compressed high-frequency data storage region 110b and acquires acquire compressed high-frequency data of the regions 40b, 40c, and 40d from regions corresponding to the addresses, respectively.

The motion search unit 130c decodes the compressed high-frequency data of the regions 40b, 40c, and 40d, integrates the decoded data with the data of the region 40a of the low-frequency data 120a and reconstructs image data of the motion search range 40. The image data of the motion search range 40 may correspond to the search range image data 125b. The motion search unit 130c compares a motion search range 40 of a previous frame with a motion search range 40 of a present frame, specifies a distance and a direction of motion of a shooting subject and specifies a motion vector. The motion search unit 130c performs DCT quantization and entropy coding based on the motion vector and outputs a result of the entropy coding to an external device.

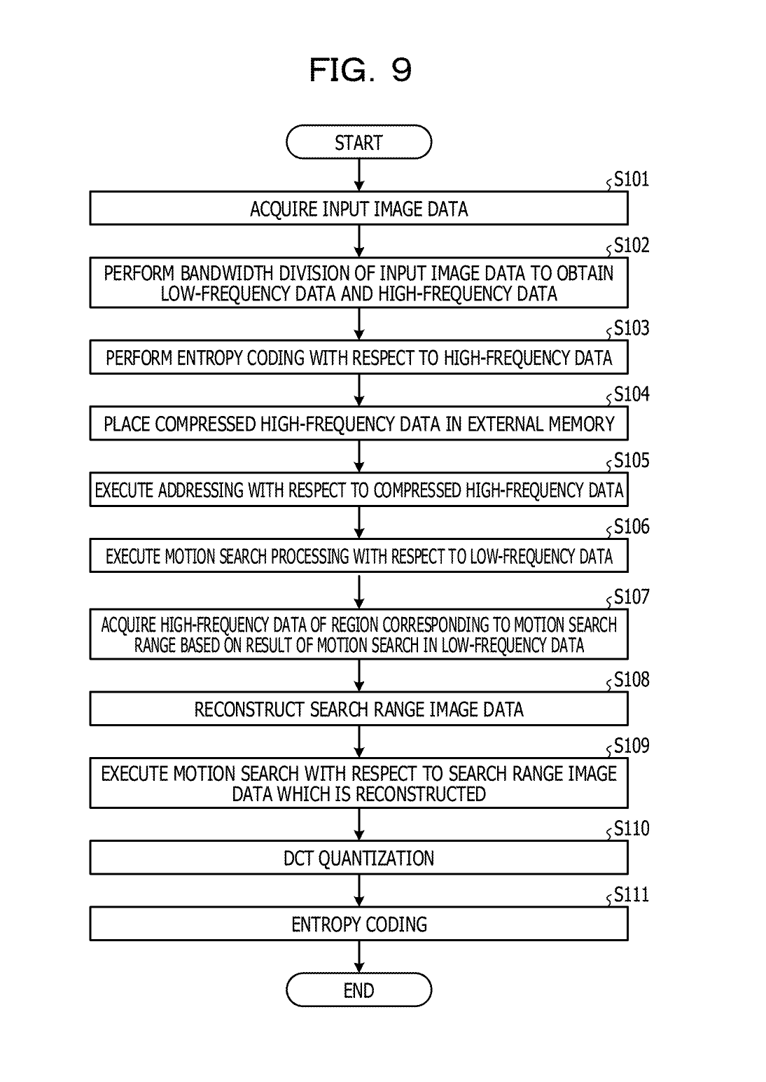

FIG. 9 illustrates an example of processing of a motion search processing device. As illustrated in FIG. 9, the generation unit 130a of the motion search processing device 100 acquires the input image data 110a (operation S101) and performs bandwidth division of the input image data 110a to obtain low-frequency data and high-frequency data (operation S102).

The compression unit 130b of the motion search processing device 100 performs entropy coding with respect to the high-frequency data and generates compressed high-frequency data (operation S103). The compression unit 130b places the compressed high-frequency data in the external memory 110 (operation S104) and executes addressing with respect to the compressed high-frequency data so as to generate the management table 125a (operation S105).

The motion search unit 130c of the motion search processing device 100 executes motion search processing with respect to the low-frequency data 120a (operation S106). The motion search unit 130c acquires high-frequency data of a region corresponding to a motion search range based on a result of the motion search in the low-frequency data (operation S107).

The motion search unit 130c of the motion search processing device 100 reconstructs the search range image data 125b (operation S108). The motion search unit 130c executes motion search with respect to the search range image data which is reconstructed, and obtains a motion vector (operation S109). The motion search unit 130c executes DCT quantization (operation S110) and performs entropy coding (operation S111).

The motion search processing device 100 performs bandwidth division with respect to the input image data 110a, generates the low-frequency data 120a and the high-frequency data, and stores compressed high-frequency data in the external memory 110. The motion search processing device 100 executes motion search processing with respect to the low-frequency data 120a, specifies a motion search range, reads high-frequency data corresponding to the motion search range from the external memory 110, reconstructs the search range image data 125b, and executes the motion search processing. Therefore, the motion search processing device 100 may efficiently execute the motion search.

For example, compressed high-frequency data which is stored in the external memory 110 is obtained by performing entropy coding with respect to high-frequency data of small entropy, so that the data amount of the compressed high-frequency data may be small and thus, the motion search processing may be executed with a small data transfer amount. Data capacity of the external memory 110 may be reduced.

The motion search processing device 100 specifies a motion search range through first motion search processing, reads only high-frequency data corresponding to this motion search range from the external memory 110, reconstructs image data, and performs the motion search processing. Therefore, the motion search may be performed with minimum data and the data transfer amount may be reduced.

When the motion search processing device 100 stores compressed high-frequency data in the compressed high-frequency data storage region 110b, the motion search processing device 100 performs addressing with respect to the compressed high-frequency data and generates the management table 125a. Therefore, compressed image data within a motion search range may be efficiently acquired from the external memory 110.

The motion search unit 130c of the motion search processing device 100 may execute motion search processing of two stages, for example, and may execute motion search of n stages. Here, n is a natural number which is three or more. For example, when n is “3” in the processing, which is illustrated in FIG. 5, of the motion search unit 130c, the motion search unit 130c executes first motion search processing with respect to the low-frequency data 120a and specifies a first motion search range. The motion search unit 130c executes second motion search processing with respect to the high-frequency data 120b which is included in the first motion search range and specifies a second motion search range.

The motion search unit 130c acquires data corresponding to the second motion search range from the low-frequency data 120a and the high-frequency data 120b to 120d and reconstructs image data within the second motion search range. The motion search unit 130c calculates a motion vector with respect to the image data which is reconstructed.

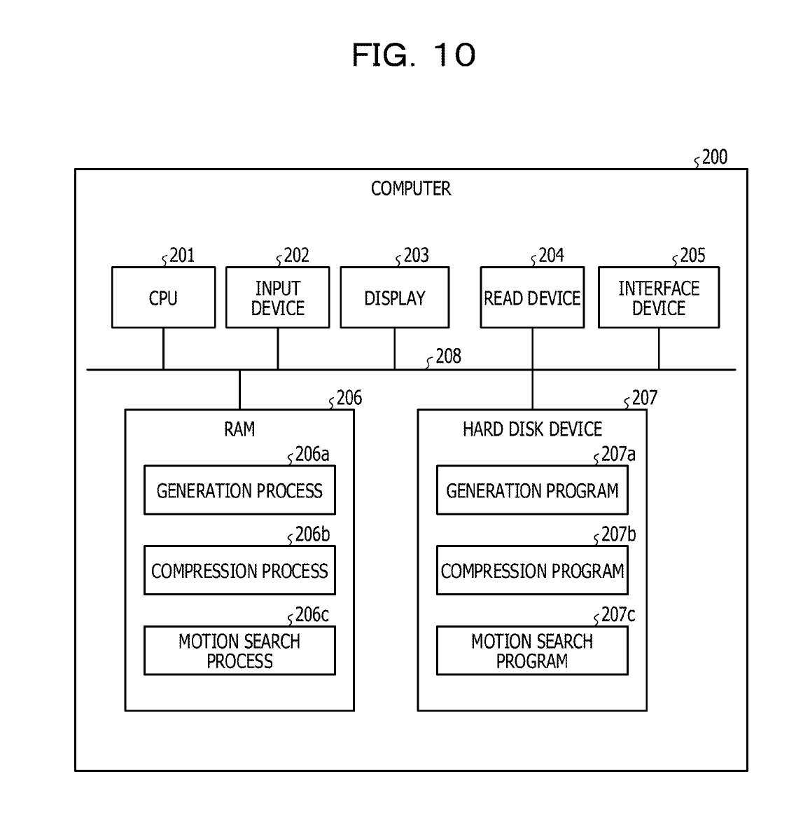

FIG. 10 illustrates an example of a computer. The computer illustrated in FIG. 10 may execute a motion search processing program. For example, the computer illustrated in FIG. 10 may execute a video data processing program by which a function equivalent to that of the motion search processing device 100 described above is realized.

As illustrated in FIG. 10, a computer 200 includes a CPU 201 which executes various kinds of arithmetic processing, an input device 202 which receives input of data from a user, and a display 203. The computer 200 includes a read device 204 which reads a program and so forth from a storage medium and an interface device 205 which transmits/receives data to/from another computer via a network. The computer 200 includes a RAM 206 which temporarily stores various types of information and a hard disk device 207. The CPU 201, the input device 202, the display 203, the read device 204, the interface device 205, the RAM 206, and the hard disk device 207 are coupled to a bus 208 respectively.

The hard disk device 207 includes a generation program 207a, a compression program 207b, and a motion search program 207c. The CPU 201 reads the generation program 207a, the compression program 207b, and the motion search program 207c and develops the generation program 207a, the compression program 207b, and the motion search program 207c on the RAM 206. The generation program 207a functions as a generation process 206a. The compression program 207b functions as a compression process 206b. The motion search program 207c functions as a motion search process 206c.

For example, processing of the generation process 206a may correspond to processing of the generation unit 130a. Processing of the compression process 206b may correspond to processing of the compression unit 130b. Processing of the motion search process 206c may correspond to processing of the motion search unit 130c.

The generation program 207a, the compression program 207b, and the motion search program 207c do not have to be stored in the hard disk device 207 from the beginning. For example, a “portable physical medium” such as a flexible disk (FD), a CD-ROM, a DVD disk, a magneto-optical disk, and an IC card which are inserted into the computer 200 stores each of the generation program 207a, the compression program 207b, and the motion search program 207c. The computer 200 may read each of the generation program 207a, the compression program 207b, and the motion search program 207c from the “portable physical medium” and executes each of the generation program 207a, the compression program 207b, and the motion search program 207c.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A motion search processing method comprising:
dividing, by a computer, first image data included in video data in accordance with a frequency band and generating a plurality of pieces of divided image data;
performing compression processing on first divided image data among the plurality of pieces of divided image data and generating compressed divided image data, the first divided image data including a frequency component of which a frequency band is equal to or more than a value;
performing first motion search processing on the video data by using second divided image data among the plurality of pieces of divided image data, the second divided image data including a frequency component of which a frequency band is less than the value; and
generating second image data by using the plurality of pieces of divided image data and performing second motion search processing by using the second image data.

2. The motion search processing method according to claim 1, further comprising:
storing address information of an address on which the compressed divided image data is stored and position information of the first divided image data in a memory in such a manner that the address information and the position information are associated with each other.

3. The motion search processing method according to claim 2, further comprising:
storing the address information and size information of the compressed divided image data in the memory in such a manner that the address information and the size information are associated with each other.

4. The motion search processing method according to claim 1, wherein, in the first motion search processing,
a motion vector is calculated by using the second divided image data, and
a motion search range is specified based on the motion vector.

5. The motion search processing method according to claim 1, wherein, in the second motion search processing,
the first divided image data included in a motion search range which is specified based on a processing result of the first motion search processing, is read from an external memory, and
image data within the motion search range is generated by using the first divided image data which is read.

6. The motion search processing method according to claim 5, wherein the first divided image data is read from an external memory.

7. The motion search processing method according to claim 4, wherein, in the second motion search processing,
the first divided image data included in a motion search range which is specified based on a processing result of the first motion search processing, is read, and
image data within the motion search range is generated by using the first divided image data which is read.

8. A motion search processing device comprising:
a processor configured to execute a data processing program; and
a memory configured to store the data processing program; wherein the processor:
divides first image data included in video data in accordance with a frequency band and generates a plurality of pieces of divided image data;
performs compression processing on first divided image data, among the plurality of pieces of divided image data and generates compressed divided image data, the first divided image data including a frequency component of which a frequency band is equal to or more than a value;
performs first motion search processing of the video data by using second divided image data among the plurality of pieces of divided image data, the second divided image data including a frequency component of which a frequency band is less than the value; and
generates second image data by using the plurality of pieces of divided image data and performs second motion search processing by using the second image data.

9. The motion search processing device according to claim 8, wherein address information of an address on which the compressed divided image data is stored and position information of the first divided image data are stored in a memory in such a manner that the address information and the position information are associated with each other.

10. The motion search processing device according to claim 9, wherein the address information and size information of the compressed divided image data are stored in the memory in such a manner that the address information and the size information are associated with each other.

11. The motion search processing device according to claim 8, wherein, in the first motion search processing,
a motion vector is calculated by using the second divided image data, and
a motion search range is specified based on the motion vector.

12. The motion search processing device according to claim 8, wherein, in the second motion search processing,
the first divided image data included in a motion search range which is specified based on a processing result of the first motion search processing, is read, and
image data within the motion search range is generated by using the first divided image data which is read.

13. The motion search processing device according to claim 12, wherein the first divided image data is read from an external memory.

14. The motion search processing device according to claim 11, wherein, in the second motion search processing,
the first divided image data included in a motion search range which is specified based on a processing result of the first motion search processing, is read from an external memory, and
image data within the motion search range is generated by using the first divided image data which is read.
